(19) United States
(12) Patent Application Publication
(10) Pub. No.: US 2022/0334583 A1
(43) Pub. Date: Oct. 20, 2022

(54) ROUTE GENERATION DEVICE

(71) Applicant: Nidec Corporation, Kyoto (JP)

(72) Inventors: Shohei IMADA, Kyoto (JP); Tomoki YOSHIKAWA, Kyoto (JP); Shuhei OGAWA, Kyoto (JP)

(21) Appl. No.: 17/764,646

(22) PCT Filed: Aug. 21, 2020
(86) PCT No.: PCT/JP2020/031590

§ 371 Date: Mar. 29, 2022

(30) Foreign Application Priority Data
Sep. 30, 2019 (JP) 2019-180471

(51) Int. Cl. G05D 1/02

(52) U.S. Cl. CPC G05D 1/0217; G05D 1/0214; G05D 1/0274; G05D 1/0238; G05D 2201/0203

(57) ABSTRACT

A contour of an accessible area is extracted from map information generated using LiDAR, and a relay point of a mobile object is quickly set based on an angle defined by a point group provided on the contour. As a result, it is possible to easily construct a safe and shortest route in consideration of obstacles from the point of departure to the destination of the mobile object.

### CROSS-REFERENCE TO RELATED APPLICATIONS

This is a U.S. national stage of application No. PCT/JP2020/031590, filed on Aug. 21, 2020, and with priority under 35 U.S.C. § 119(a) and 35 U.S.C. § 365(b) being claimed from Japanese Patent Application No. 2019-180471, filed on Sep. 30, 2019, the entire disclosures of which are hereby incorporated herein by reference.

### 1. FIELD OF THE INVENTION

The present disclosure relates to a route generation device that generates a route to a destination of an unmanned carrier or the like, for example.

### 2. BACKGROUND

Conventionally, as a guidance system for causing an unmanned carrier to travel on a target travel route in a hotel, a production line of a factory, a distribution warehouse, or the like, for example, an electromagnetic guidance system in which a guidance magnetic field transmitted from an electric wire embedded in a floor is detected by a coil mounted on the unmanned carrier, an optical system in which reflected light from a reflection tape attached to a floor surface is detected by an optical sensor, or the like is known.

On the other hand, as a method of operating and managing an unmanned carrier without using the above-described guidance method, for example, an automatic guided vehicle (AGV) that automatically travels on a target travel route to load and unload a cargo and the like has been proposed.

In such an operation management method for an unmanned carrier, a user inputs a conveyance route to the unmanned carrier in advance, and conveyance to a destination or the like is performed. Further, a method of generating a route to a destination using a route generation algorithm such as A* (Aster) is also used.

There is known a conveyance device in which a moving device moves between stations along a travel line and conveys an article between the stations. Here, when the moving device, which is an unmanned carrier, moves to the destination, information is received from a relay point (storage medium), and the moving device advances the route based on the information.

There is known a method of operating a robotic cleaning device which is an automatic self-propelled machine on a surface to be cleaned. Here, a technique is disclosed in which, during cleaning, roadmap nodes are registered at intervals on a surface to be cleaned, and when a robotic cleaning device is driven from a previously registered roadmap node to a currently registered roadmap node without colliding with an obstacle or detecting an obstacle, the roadmap nodes are connected to form a roadmap link in a roadmap diagram, whereby navigation of the robotic cleaning device is facilitated.

However, in the related art, when the user inputs a route to the AGV, if the route becomes complicated, the amount of information increases and the burden on the user side also increases.

On the other hand, when A* (Aster) that is a route generation algorithm is used, it may take a very long time to generate a route. For example, there is a problem that the wider the facility, the longer the time required for the AGV to search for the way to the destination.

### SUMMARY

A first example embodiment of the present disclosure is a route generation device that generates a route of a mobile object. The route generation device includes a map information generator to indicate an accessible area and an inaccessible area of the mobile object from predetermined map information, a processor to apply predetermined processing to a boundary line between the accessible area and the inaccessible area based on the generated map information, to set a relay point of the mobile object on the boundary line, a distance calculator to calculate a distance between the relay points from a length of a line segment linking the relay points, and a route generator to generate a route from a point of departure to a destination of the mobile object based on the relay points and the distance between the relay points.

A second example embodiment of the present disclosure is a route generation method. The method includes generating map information indicating an accessible area and an inaccessible area of a mobile object from predetermined map information, setting point groups at predetermined intervals on a boundary line between the accessible area and the inaccessible area based on the map information generated, calculating angle information obtained by extracting, from among the point groups, a point group in which an angle defined by straight lines linking predetermined point groups includes a certain value or larger, setting a relay point of the mobile object in the inaccessible area based on the angle information, calculating a distance between the relay points from a length of a line segment linking the relay points, and generating a route from a point of departure to a destination of the mobile object on a basis of the relay points and the distance between the relay points.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a block diagram illustrating a configuration of a route generation device according to a first example embodiment of the present disclosure.

FIG. 2 is a flowchart illustrating a procedure of creating map information in the route generation device according to the first example embodiment.

FIG. 3 is a flowchart illustrating a processing procedure of extracting a corner in the first example embodiment.

FIG. 4A is an example of map information created based on data captured by LiDAR according to an example embodiment of the present disclosure.

FIG. 4B illustrates an example in which an inaccessible area is set to the black area illustrated in FIG. 4A.

FIG. 4C illustrates an extracted passage route of an automatic guided vehicle AGV according to an example embodiment of the present disclosure.

FIG. 4D illustrates an example of a corner extracted based on angle information according to an example embodiment of the present disclosure.

FIG. 4E illustrates an example in which extracted corners are integrated into one according to an example embodiment of the present disclosure.

FIG. 4F illustrates an example of a route formed by a first method according to an example embodiment of the present disclosure.

FIG. 4G illustrates an example of a route formed by a second method according to an example embodiment of the present disclosure.

FIG. 5 illustrates a method of extracting a corner based on an angle formed by a point group according to an example embodiment of the present disclosure.

FIG. 6 is a flowchart illustrating a procedure of determining a route of an AGV in which a destination is designated, in the first example embodiment.

FIG. 7 is an example of a moving route of an AGV, formed by connecting corners by the first method.

FIG. 8 is an example of a moving route of an AGV, formed by connecting corners by the second method.

FIG. 9 is a flowchart illustrating a procedure of creating map information in a route generation device according to a second example embodiment of the present disclosure.

FIG. 10A is an example of map information created by LiDAR according to an example embodiment of the present disclosure.

FIG. 10B illustrates an example of a point group map generated from map information according to an example embodiment of the present disclosure.

FIG. 10C illustrates a result of processing of leaving only line segments having a certain length or more from the point group map.

FIG. 10D illustrates a map of end points of an extracted line segment according to an example embodiment of the present disclosure.

FIG. 10E is a map created by extending a straight line in the most open direction from each end point according to an example embodiment of the present disclosure.

FIG. 10F is a map illustrating a corner extracted by extending from an end point determined to be an acute angle or an obtuse angle except for an end point determined to be a plane according to an example embodiment of the present disclosure.

FIG. 10G is a map when corners are connected according to an example embodiment of the present disclosure.

FIG. 11 illustrates an example of a moving route of an AGV to a destination in the second example embodiment.

FIG. 12 is an illustration for explaining map generation according to a first modification of an example embodiment of the present disclosure.

FIG. 13 is an illustration explaining setting of an inaccessible area according to a second modification of an example embodiment of the present disclosure.

### DETAILED DESCRIPTION

Example embodiments according to the present disclosure will be described in detail below with reference to the accompanying drawings.

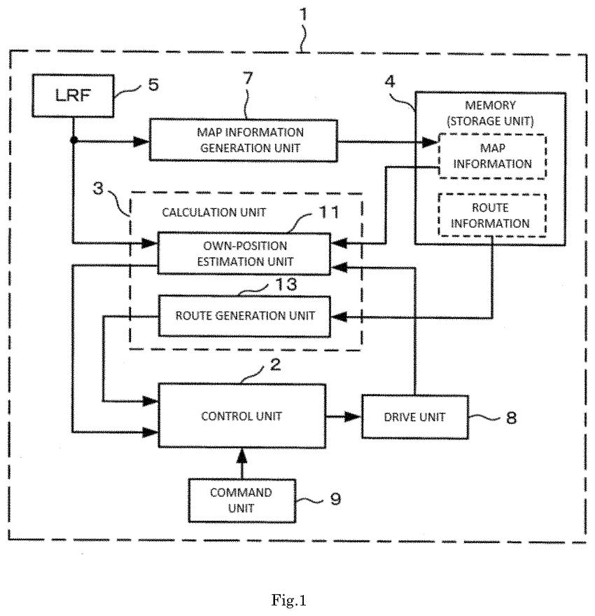

FIG. 1 is a block diagram illustrating a configuration of a route generation device according to a first example embodiment of the present disclosure. A route generation device travels a traveling route from a point of departure to a designated destination in a facility such as a hotel or a distribution warehouse, as a mobile object (automatic guided vehicle AGV). Therefore, the route generation device 1 creates map information and route information of a traveling place (facility) in advance.

As illustrated in FIG. 1, the route generation device 1 includes a control unit 2, a calculation unit 3, a storage unit (memory) 4, a laser range finder (LRF) 5, a map information generation unit 7, a drive unit 8, and the like. The control unit 2 includes, for example, a microprocessor, and is responsible for controlling the entire device. The LRF 5 is a laser-type distance measuring sensor. The map information generation unit 7 generates map information of a traveling place.

The calculation unit 3 includes an own-position estimation unit 11 and a route generation unit 13. The storage unit (memory) 4 stores map information, route information, a program for creating them, a travel control program of the route generation device 1, and the like.

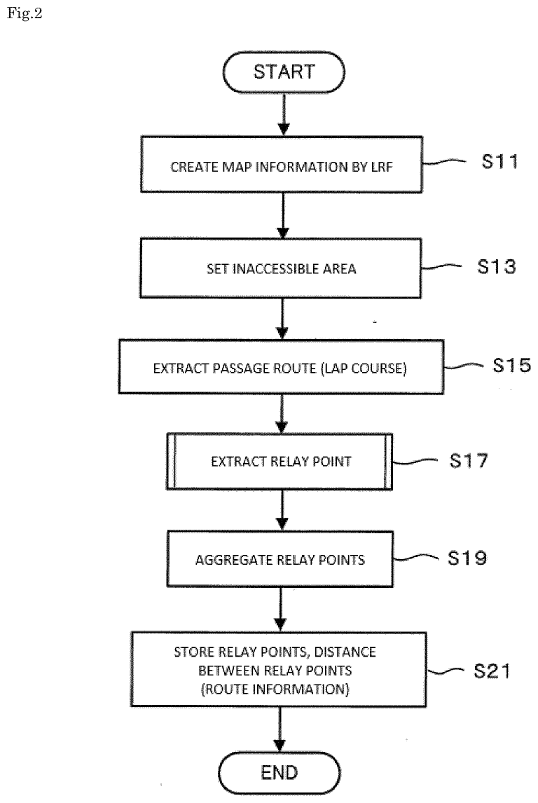

Next, a method for creating map information and route information in the route generation device according to the first example embodiment will be described. FIG. 2 is a flowchart illustrating a procedure for creating map information in a time-series manner in the route generation device according to the first example embodiment.

In step S11 of FIG. 2, the control unit 2 of the route generation device 1 uses, for example, Light Detection and Ranging (LiDAR) as an LRF to detect an obstacle (for example, a wall, a pillar, a load, and the like) that interferes with travel of the automatic guided vehicle AGV (here, the route generation device 1) in a facility such as a hotel or a distribution warehouse, and creates map information on the basis of the obstacle.

The LiDAR is a technique of emitting a laser to a two-dimensional space or a three-dimensional space in a predetermined area called a facility and measuring distances at a plurality of measurement points in the area.

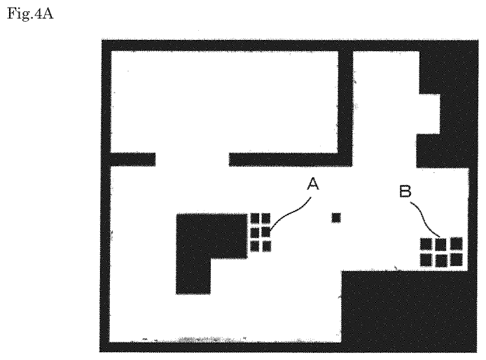

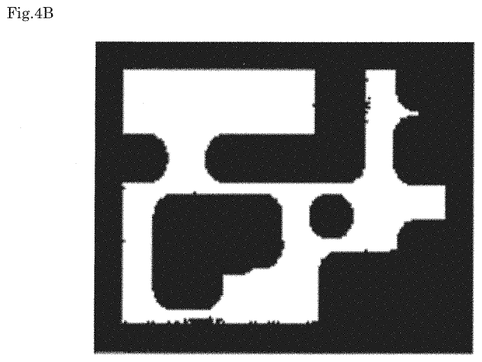

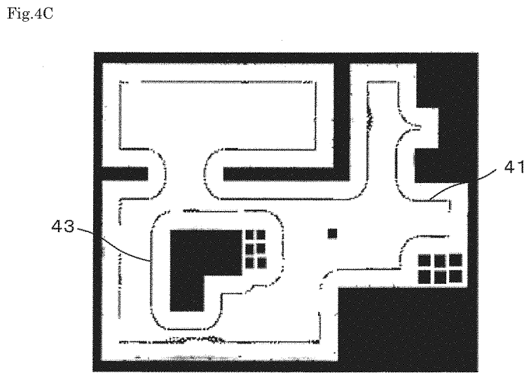

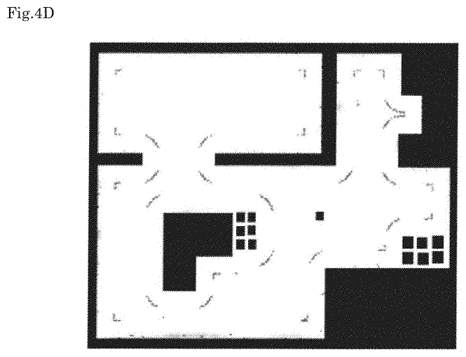

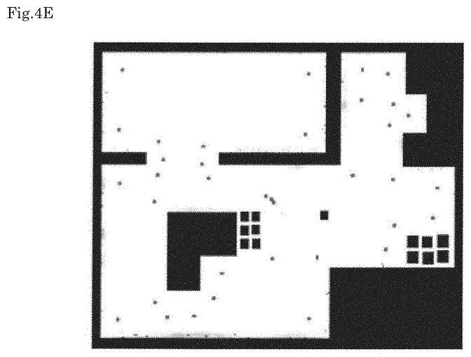

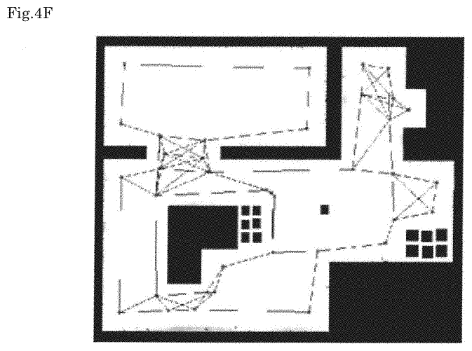

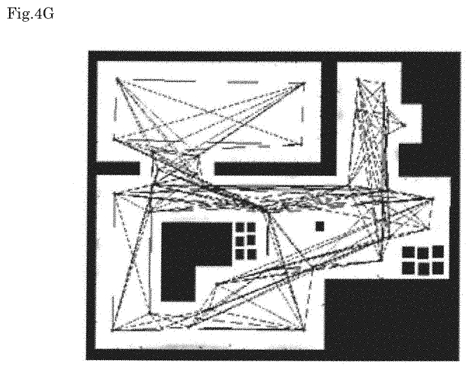

FIG. 4A is an example of map information created based on data captured by LiDAR, which is two-dimensional map information representing information such as a position and a shape of a target region. In the map information illustrated in FIG. 4A, it is assumed that there are obstacles (for example, temporarily placed corrugated cardboard, load, and the like indicated by reference signs A and B in FIG. 4A) in a portion that is not detected by LiDAR, and the area is filled in advance.

In step S13, the control unit 2 performs a process of setting an area at a certain distance from the detected obstacle as an “inaccessible area” where the automatic guided vehicle AGV cannot enter. Specifically, a portion at a certain distance (for example, the length of the diagonal line of the automatic guided vehicle AGV) from the edge of the black portion in FIG. 4A is defined as an inaccessible area. FIG. 4B illustrates an example in which an inaccessible area is set for the black region illustrated in FIG. 4A.

Here, for example, based on the outer size of the automatic guided vehicle AGV or the like, an accessible area where the AGV can move without colliding with a person or an object and an inaccessible area where the AGV cannot move are determined. When the image illustrated in FIG. 4B is obtained from the image illustrated in FIG. 4A, processing of removing image noise generated in the image information acquired by LiDAR may be performed.

In step S15, as illustrated in FIG. 4C, the control unit 2 extracts the contour portion of the inaccessible area provided in step S13 as passage routes 41 and 43 of the automatic guided vehicle AGV. At that time, processing of removing an obstacle of a predetermined size or less may be performed. As can be seen from FIG. 4C, the extracted passage routes 41 and 43 are lap courses.

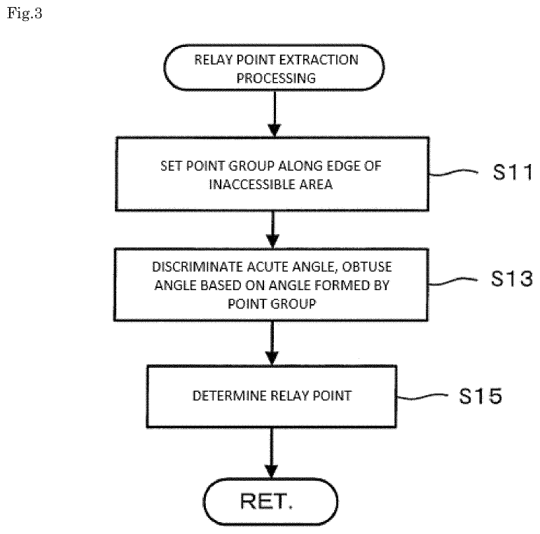

In step S17, the control unit 2 extracts a corner (relay point) based on the passage route (contour portion to be described later) extracted in step S15. FIG. 3 is a flowchart illustrating the procedure for corner extraction processing.

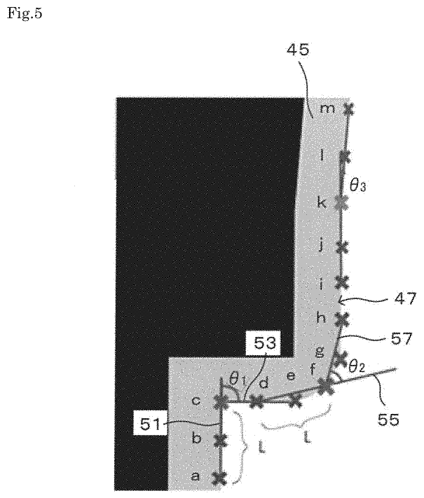

That is, in step S31 of FIG. 3, for example, as illustrated in FIG. 5, the control unit 2 provides point groups (indicated by cross marks in FIG. 5) at certain intervals along the contour portion (edge) 47 of the inaccessible area 45. These point groups are also candidates for corners.

In step S33, the control unit 2 discriminates an acute angle, an obtuse angle, and the like, on the basis of the angle formed by the point group. In general, an acute angle refers to an angle of 90° or less, and an obtuse angle refers to an angle larger than 90° and smaller than 180°. Here, as described later, when one straight line is inclined by a certain value (for example, 45°) or more with respect to the other straight line, the angle is defined as an acute angle or an obtuse angle, and a point group in which an angle defined by straight lines connecting predetermined consecutive point groups has a certain value or more is extracted.

Specifically, by focusing on a point “c” in FIG. 5, when an angle θ₁ defined by straight lines 51 and 53 connecting points “a” and “e” separated from the point “c” by a certain distance L or more has a certain value or more, the angle at the point “c” can be determined to be an acute angle from FIG. 5.

Similar processing is repeated for other focusing points. For example, when an angle θ₂ defined by straight lines 55 and 57 connecting points “d” and “h” on both sides starting from a point “f” has a certain value or more, the angle at the point “f” can be determined to be an obtuse angle from FIG. 5.

That is, when calculating the angle θ formed by two straight lines (for example, a straight line “ac” and a straight line “ce” in FIG. 5), the angle θ is between 0° to 180° because it is calculated with one straight line as a starting point. In the case of FIG. 5, θ₁ is 45°, θ₂ is 135°, and θ₃ is 5°.

Therefore, since the angle θ₃ formed by the straight lines is not equal to or larger than a certain angle, the angle θ₃ is determined to be an angle other than an obtuse angle and an acute angle. FIG. 4D illustrates exemplary corners extracted based on the angle information obtained through such processing.

In step S35, the control unit 2 determines, as a corner, a point corresponding to an acute angle or an obtuse angle whose angle is equal to or larger than a certain value, on the basis of the discrimination result of the angle in step S33 described above. As a result, it is possible to efficiently set corners and reduce the amount of information at that time.

When the corner extraction process illustrated in FIG. 3 ends, in step S19 of FIG. 2, a process of aggregating points in a short distance, among the corners extracted as described above, as one corner is performed.

FIG. 4E illustrates an example in which respective corners extracted in step S17 described above are aggregated into one in step S19. The respective corners shown in FIG. 4E include an in-corner corresponding to an acute angle and an out-corner corresponding to an obtuse angle, as can be seen with reference to FIG. 4D.

Next, in step S21 of FIG. 2, the control unit 2 connects corners (relay points), and calculates the distance from the length of the line segment. Connection between corners is performed by connecting corners without an obstacle therebetween. Then, these corners and the calculated distance are stored in the memory 4 as route information. The following two methods can be adopted as a connection method between the corners.

As a first method, adjacent corners on each lap course described above are connected to each other, and a distance of a line segment formed by the connection is stored. In addition, the corners that are not adjacent to each other are also connected together including other lap courses if the corners are within a certain distance, and the distance of the formed line segment is stored. In this way, for example, it is possible to avoid a state where the automatic guided vehicle AGV basically continues traveling one lap course and does not travel other lap courses as much as possible. An example of a route formed in this manner is shown in FIG. 4F.

A second method is a method of connecting all corners and storing the distance of a line segment formed by the connection. FIG. 4G is an example of a route formed by connecting all corners. Which method is to be adopted is selected by, for example, the user of the route generation device.

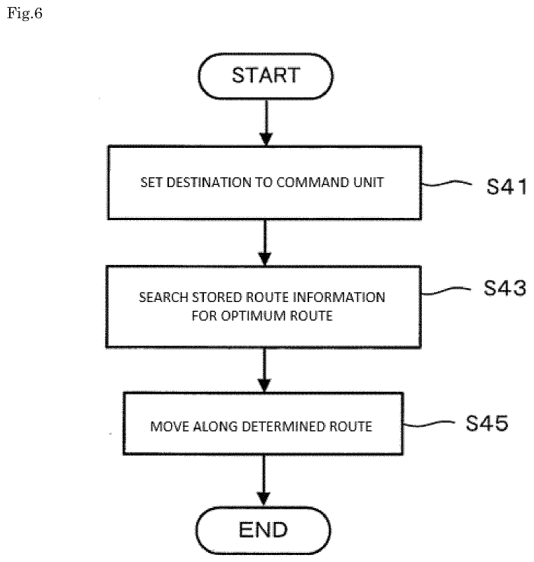

Next, processing of determining a route to a destination in the route generation device will be described. FIG. 6 is a flowchart illustrating a procedure for determining a route by an automatic guided vehicle AGV (route generation device) in the case where a destination is designated. In step S41 of FIG. 6, the control unit 2 allows the user to set a destination (transfer target position) to a command unit 9 of the route generation device 1. The command unit 9 includes keys, a touch screen, and the like for inputting information.

In step S43, the route generation device 1 searches for an optimum route from the combinations of the corners (relay points) from the current location to the destination and the distance between the corners, based on the route information stored in the memory 4. Here, the “optimum route” means a route having the shortest moving distance or the shortest route passing by the wall of the building as much as possible. The route searched in this way is a route in which movement of the automatic guided vehicle AGV does not interfere with the passerby or the like.

In step S45, the control unit 2 moves the automatic guided vehicle AGV while controlling the drive unit 8 such that it moves along the route searched for and determined in step S43. In the case of moving the AGV to the destination, the optimum route is autonomously determined from the coordinates of the corner and the distance information between the corners, and the AGV is moved. The drive unit 8 includes, for example, a known drive mechanism including a plurality of wheels, a motor that drives these wheels, and the like.

During the movement, an own-position estimation unit 11 of the route generation device 1 obtains the movement amount from the rotation angle of the wheel or the like by odometry for example, and estimates the position of the AGV from the accumulation result. In addition, simultaneous localization and mapping (SLAM) may be used to estimate the own-position.

When the destination is not on the relay points, a relay point located closest to the destination is checked. Then, an optimum route is searched for by using between the relay points. At the time of movement, the vehicle first moves to the nearest relay point, follows the route searched above, and moves from the last relay point to the destination.

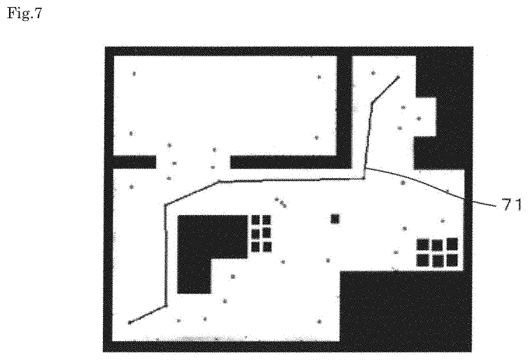

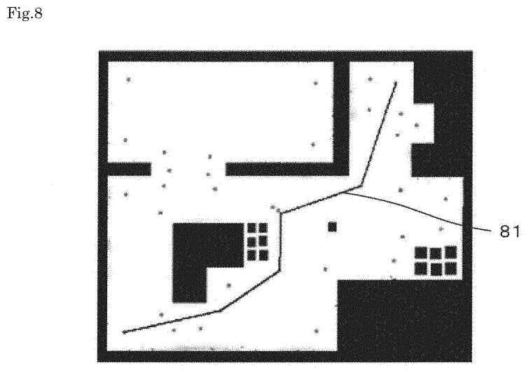

FIG. 7 illustrates an example of a moving route of an automatic guided vehicle AGV, formed by connecting corners by the first method described above and searched for based on the route information illustrated in FIG. 4F. FIG. 8 is an example of a moving route of an automatic guided vehicle AGV, formed by connecting all corners by the second method described above and searched for based on the route information illustrated in FIG. 4G.

A movement route 71 in FIG. 7 is a route for moving a large frame attached to a wall, and a movement route 81 in FIG. 8 is a route for moving across the center of the passage. Therefore, it can be said that the movement route 71 of FIG. 7 is a movement route that does not interfere with the movement of the passerby as much as possible as compared with the movement route 81 of FIG. 8.

As described above, according to the route generation device of the first example embodiment, the contour of the accessible area is extracted from the generated map information, and relay points of the mobile object (AGV) can be quickly set on the basis of the angles formed by the point groups provided to the contour. Therefore, it is easy to generate a safe and shortest route from the point of departure to the destination in consideration of obstacles.

That is, it is possible to generate a highly reliable route in which relay points are efficiently set in consideration of presence or absence of an obstacle. In addition, by generating the route information in which the corners without an obstacle are connected in the accessible area, it is possible to generate a shortest route between the point of departure and the destination without interfering with passage of a person or movement of an object.

Next, a second example embodiment of the present disclosure will be described. Since the configuration of a route generation device according to the second example embodiment is the same as that of the route generation device according to the first example embodiment illustrated in FIG. 1, the description thereof will be omitted here.

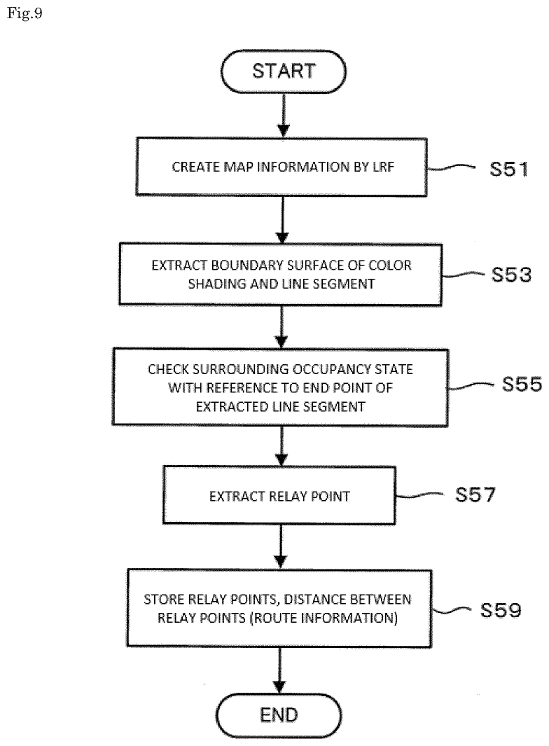

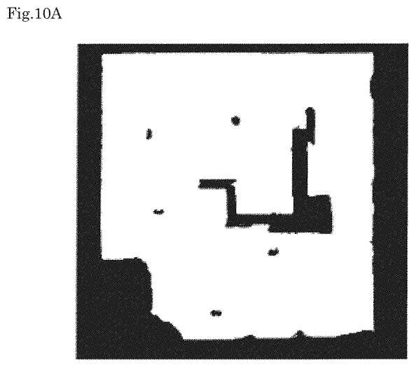

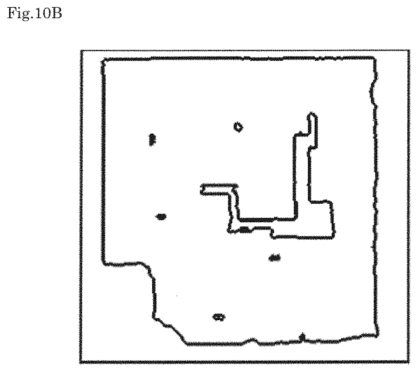

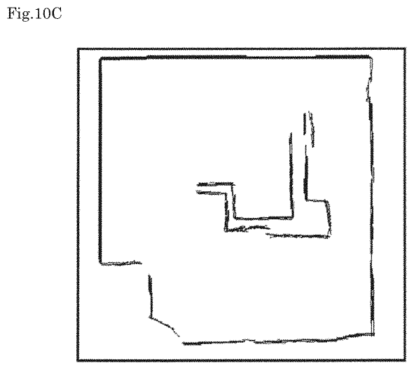

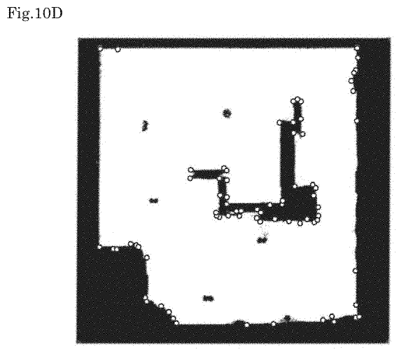

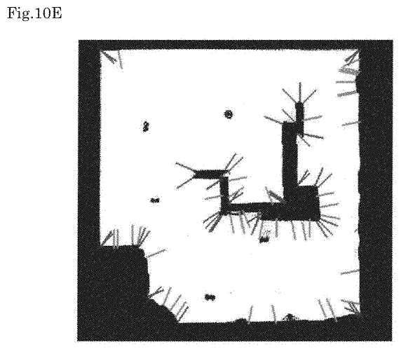

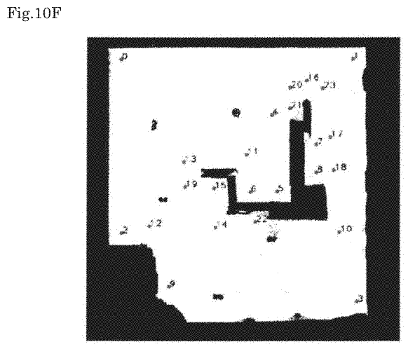

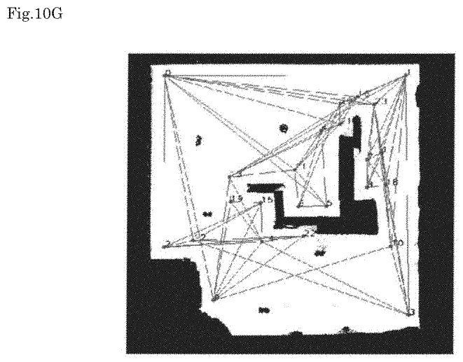

FIG. 9 is a flowchart illustrating a procedure for creating map information in a time-series manner in the route generation device according to the second example embodiment. In step S51 of FIG. 9, the control unit 2 creates map information by using light detection and ranging (LiDAR), similarly to the first example embodiment (step S11 of FIG. 2). FIG. 10A is an example of the created map information, and the black portion is an obstacle.

In step S53, the control unit 2 detects a boundary surface of color shading in the map information illustrated in FIG. 10A and generates, for example, a point group map illustrated in FIG. 10B. Then, as illustrated in FIG. 10C, a process of leaving only line segments of a certain length or more (for example, the length of an obstacle such as corrugated cardboard or cone to be removed from the map) from the point group map of FIG. 10B is performed. Since the point group map in FIG. 10B has a large amount of information, the process of determining presence or absence of a corner thereafter can be speeded up by detecting the line segment as in FIG. 10C.

In step S55, the control unit 2 checks the surrounding occupancy state (presence or absence of an obstacle) with reference to the end point of the line segment extracted in step S53 described above. FIG. 10D is a map showing end points (outlined circle marks) of line segments, and FIG. 10E is a map created by extending straight lines of a predetermined length (for example, the length of the diagonal line of the automatic guided vehicle AGV) in the most open direction from each end point.

For example, when the end point is opened by about 90°, the occupancy of the surroundings is set to 0.25, when the end point is opened by 180°, the occupancy of the surroundings is set to 0.5, and when the end point is opened by about 270°, the occupancy of the surroundings is set to 0.75.

The occupancy is a degree of expansion of a line segment to the periphery with an end point as a reference, and here, an acute angle, an obtuse angle, and a plane are determined from the occupancy. For example, the occupancy 0.25 is determined to be an acute angle, the occupancy 0.75 is determined to be an obtuse angle, and the occupancy 0.5 is determined to be a plane.

FIG. 10F is a map illustrating a corner extracted by extending the corner by a certain distance (for example, the length of the diagonal line of the automatic guided vehicle AGV) in the most open direction from the end point determined to be an acute angle or an obtuse angle, except for the end point determined to be a plane. The extracted corners are assigned with serial numbers.

In step S59, the corners are connected as illustrated in FIG. 10G, and these corners and the calculated distance are stored in the memory 4 as route information.

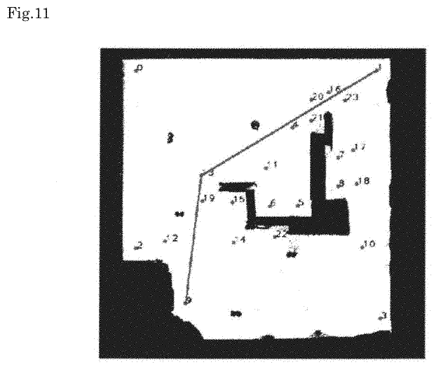

Note that, in the second example embodiment, the process of designating the destination and determining the route to the destination by the automatic guided vehicle AGV (route generation device) is the same as that in the first example embodiment illustrated in FIG. 6, and thus the description thereof will be omitted. Note that FIG. 11 illustrates an example of a movement route of the automatic guided vehicle AGV to the destination, which is searched for from the route information in the second example embodiment.

As described above, according to the route generation device of the second example embodiment, it is possible to extract corners on the basis of map information in which the amount of information is reduced from that of the map information created by the LRF, and to speed up the corner setting processing. In particular, in a facility having a simple structure, a route between the point of departure and the destination can be efficiently generated.

The present disclosure is not limited to the above-described example embodiment, and various modifications are possible.

In the route generation devices according to the first and second example embodiments described above, in the case of creating map information, an obstacle is detected using a single LRF (LiDAR), but the present disclosure is not limited thereto.

For example, LRF1 and LRF2 may be installed at different positions in the height direction of the route generation device, and a map may be created on the basis of information obtained therefrom. In this case, when any of the LRFs detects an obstacle, a two-dimensional map is created assuming that the detection point has an obstacle.

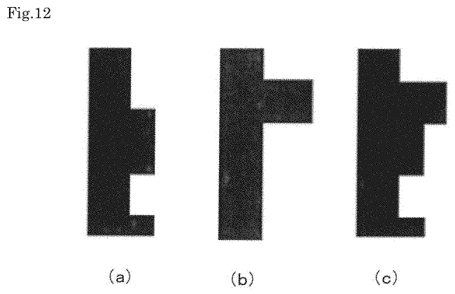

Specifically, when an obstacle illustrated in FIG. 12(a) is detected by the LRF1 and an obstacle illustrated in FIG. 12(b) is detected by the LRF2, these two detection results are combined to create a map illustrated in FIG. 12(c). As a result, three-dimensional information about the obstacle can be incorporated into the two-dimensional map.

In the route generation device according to the first example embodiment, an inaccessible area is provided in consideration of the shape and the like of the AGV, but the present disclosure is not limited thereto.

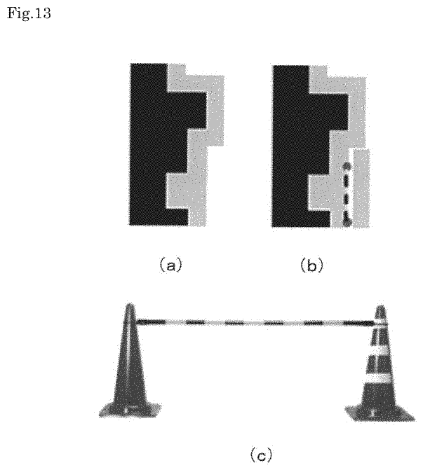

For example, a camera may be installed in the route generation device in addition to the LRF, and an inaccessible area may be provided using information captured by the camera. Specifically, in the case where “entry prohibited cones” illustrated in FIG. 13(c) are captured by the camera, the camera information may be added to the inaccessible area set on the basis of the LRF illustrated in FIG. 13(a) to set an inaccessible area as illustrated in FIG. 13(b). As a result, more accurate obstacle information can be incorporated into the map information.

Note that the camera may be a two-dimensional camera that generates two-dimensional image data or a three-dimensional camera that generates three-dimensional distance image data.

In the first and second example embodiments described above, the processing of detecting corners is performed on the already-created map information, but the map may be created by the AGV equipped with a camera, and the coordinates of a specific structure (for example, a door or the like) recognized by the camera during creation of the map may be supplementarily added as a corner.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-14. (canceled)

15. A route generation device that generates a route of a mobile object, the route generation device comprising:
a map information generator to indicate an accessible area and an inaccessible area of the mobile object from predetermined map information;
a processor to apply predetermined processing to a boundary line between the accessible area and the inaccessible area based on the map information generated, to set a relay point of the mobile object on the boundary line;
a distance calculator to calculate a distance between the relay points from a length of a line segment linking the relay points; and
a route generator to generate a route from a point of departure to a destination of the mobile object based on the relay points and the distance between the relay points.

16. The route generation device according to claim 15, wherein the predetermined processing includes:
providing point groups on the boundary line at predetermined intervals;
extracting, from among the point groups, a point group in which an angle defined by straight lines connecting predetermined point groups is equal to or larger than a certain value; and
calculating angle information.

17. The route generation device according to claim 16, wherein the relay point is set by aggregating intersections of straight lines defining an angle equal to or larger than a certain value, each of the straight lines connecting two adjacent points at a predetermined distance or more in two directions along the boundary line with respect to an arbitrary point defining the point group.

18. The route generation device according to claim 15, wherein the distance calculator calculates the distance between the relay points from a length of a line segment obtained by linking adjacent relay points in a predetermined lap route in the accessible area.

19. The route generation device according to claim 15, wherein the distance calculator calculates the distance between the relay points from a length of a line segment obtained by linking all of the relay points in the accessible area.

20. The route generation device according to claim 15, wherein the map information generated is map information obtained by performing image processing on imaged data obtained by imaging a predetermined object and a surrounding environment.

21. The route generation device that generates a route of a mobile object according to claim 15, wherein the accessible area and the inaccessible area are determined based on information including at least an outer size of the mobile vehicle.

22. The route generation device according to claim 15, wherein the mobile object is an automatic guided vehicle.

23. A route generation device that generates a route of a mobile object, the route generation device comprising:
a detector to detect a boundary surface or a line segment of a predetermined object on a basis of predetermined map information;
a map information generator to generate map information including the boundary surface or the line segment;
a processor to apply predetermined processing to the map information generated, to set a relay point of the mobile object;
a calculator to calculate route information based on a line segment linking the relay points; and
a route generator to generate a route from a point of departure to a destination of the mobile object based on the route information.

24. The route generation device according to claim 23, wherein the detector extracts an end portion of a line segment having a predetermined length or more from a point group defining the boundary surface or the line segment.

25. The route generation device according to claim 24, wherein the predetermined processing is processing based on angle information obtained from a surrounding occupancy state with reference to the end portion.

26. The route generation device according to claim 25, wherein the relay point is set at a position extending from the boundary surface or the end portion of the straight line by a predetermined distance based on the angle information.

27. The route generation device that generates a route of a mobile object according to claim 23, wherein the mobile object is an automatic guided vehicle.

28. A route generation method comprising the steps of:
generating map information indicating an accessible area and an inaccessible area of a mobile object from predetermined map information;
setting point groups at predetermined intervals on a boundary line between the accessible area and the inaccessible area based on the map information generated;
calculating angle information obtained by extracting, from among the point groups, a point group in which an angle defined by straight lines linking predetermined point groups has a certain value or larger;
setting a relay point of the mobile object in the inaccessible area based on the angle information;
calculating a distance between the relay points from a length of a line segment linking the relay points; and
generating a route from a point of departure to a destination of the mobile object based on the relay points and the distance between the relay points.
